(19) United States
(12) Patent Application Publication
(10) Pub. No.: US 2013/0117650 A1
(43) Pub. Date: May 9, 2013

(54) Generating reproducible reports used in predictive modeling actions

(71) Applicants: C. James MacLennan, Redmond, WA (US); Ioan Bogdan Crivat, Woodinville, WA (US)

(72) Inventors: C. James MacLennan, Redmond, WA (US); Ioan Bogdan Crivat, Woodinville, WA (US)

(21) Appl. No.: 13/506,102

(22) Filed: Mar. 27, 2012

Related U.S. Application Data
(60) Provisional application No. 61/516,168, filed on Mar. 29, 2011.

(51) Int. Cl. G06F 17/24

(52) U.S. Cl. CPC G06F 17/246
USPC 715/217

(57) ABSTRACT

A method and system that generate reproducible reports describing one or more analytical functions are disclosed. The reports describe a sequence of analytical functions and allow subsequent executions of the sequence of analytical functions. The matrix space that is inherent in worksheets is used to record a sequence of operations as a tabular report that can be interpreted by a computer program.

### REFERENCE TO RELATED APPLICATION

This application claims the benefit of U.S. Provisional Patent Application Ser. No. 61/516168, filed Mar. 29, 2011.

### TECHNICAL FIELD

The present disclosure generally relates to generating reproducible reports using various workbook technologies.

### BACKGROUND

Historically, data in various workbook technologies (e.g., Microsoft Excel) is stored in a series of objects called “worksheets,” which are made of cells that are indexed by rows and columns that can be manipulated through a graphical user interface. Some conventional applications have used such data in a variety of analytical functions, including predictive analytics and data mining. Workbook packages often include scripting components that describe, in a computer programming language, sets of operations that are performed over data with the purpose of inspecting the operation flow and allowing subsequent executions.

As a particular example, an analytics application can automate an analytics task using a programming or scripting language. Scripting languages typically offer very good flexibility, but require extensive knowledge of scripting syntax and of the programming libraries typically used in such scripts.

For example, a classification task can be executed using the following Waikato Environment for Knowledge Analysis (WEKA) script:

//load data
ArffLoader loader = new ArffLoader();
Loader.setFile(new File(“/some/where/data.arff ”));
Instances structure = loader.getStructure();
Structure.setClassIndex(structure.numAttributes() − 1);
//train NaiveBayes
NaiveBayesUpdatable nb = new NaiveBayesUpdatable();
Nb.buildClassifier(structure);

As another example, a classification task can be executed in Microsoft Excel using a VBA macro and a custom extension library:

```
Sub Macro1()
‘Macro1 Macro
  Application.Run “Predixion.XLAM!Classification”, “A1”, “B1000”, 30,
  1000,
“Some dataset”
End Sub
```

Currently, there are numerous other programming techniques that are just as complicated and require a higher level of programming knowledge and skill to accomplish than the average user may have acquired.

### SUMMARY

Various disclosed embodiments can reduce the higher degree of programming skills required to accomplish reproducible report producing tasks. A method and system that generate reproducible results describing one or more analytical functions are disclosed. These reports describe a sequence of analytical functions and allow subsequent executions of that sequence of analytical functions. The matrix space inherent to worksheets is used to record a sequence of operations as a tabular report that can be interpreted by a computer program.

One embodiment is directed to a computer-implemented method of generating a reproducible task report. A computer is used to provide a spreadsheet environment. A worksheet is defined in the spreadsheet environment. The worksheet comprises a plurality of cells, each of which stores a respective value. Values in at least a subset of the plurality of cells are replaced with replacement values. A model is created for performing a reproducible task. The accuracy of the model for performing the reproducible task is evaluated. The steps of replacing the values, creating the model, and evaluating the accuracy of the model are performed based on a plurality of parameters contained in a table. This method may be implemented in a computer-readable storage medium or in a computer system.

These and other features, aspects, and advantages of the disclosed subject matter will be apparent to those skilled in the art from the following detailed description of preferred non-limiting exemplary embodiments, taken together with the drawings and the claims that follow.

### BRIEF DESCRIPTION OF THE DRAWINGS

It is to be understood that the drawings are to be used for the purposes of exemplary illustration only and not as a definition of the limits of the disclosed subject matter. Throughout the disclosure, the word “exemplary” is used exclusively to mean “serving as an example, instance or illustration.” Any embodiment described as “exemplary” is not necessarily to be construed as preferred or advantageous over other embodiments.

FIG. 1 is a block diagram illustrating a computer system that can be programmed to implement various embodiments.

FIG. 2 illustrates a conventional graphical user interface (GUI) for initiating a task in a spreadsheet environment.

FIG. 3 illustrates another conventional graphical user interface for initiating the task in the spreadsheet environment.

FIG. 4 illustrates a conventional report for visually inspecting a task execution plan in the spreadsheet environment.

FIG. 5 illustrates a conventional graphical user interface for re-executing a task execution plan.

FIG. 6 is a flow diagram illustrating an example method for providing a reproducible report according to one disclosed embodiment.

FIG. 7 is an example graphical user interface for providing a reproducible report according to the method of FIG. 6.

### DETAILED DESCRIPTION OF EMBODIMENTS

The detailed description set forth below in connection with the appended drawings is intended as a description of presently non-limiting, exemplary, preferred embodiments of the invention and is not intended to represent the only forms in which the present invention may be construed, constructed and/or utilized.

The disclosed subject matter contains multiple components that work together to provide reproducible reports that excel in usability, deployability, collaboration and applicability.

The disclosed subject matter proposes a method and system for producing reproducible reports that describe one or more advanced analytical functions. These generated reports describe a sequence of analytical functions and allow subsequent executions of the same sequence of analytical functions for ease of use. Various disclosed embodiments involve using the matrix space that is inherent to worksheets to record a sequence of operations as a tabular report that can be interpreted by a computer program. This technique allows for independent formatting and other aesthetic enhancements to be included in the report. These and other enhancements may increase human readability of the report and are nonfunctional in that they do not affect the ability of a computer program to execute the report.

The disclosed subject matter may enable a greater number of less technical business users to apply cost-effective and time saving technologies in producing reproducible reports. Methods and tools are provided that can create simple and accurate reproducible reports without specific or specialized training.

In addition, the disclosed subject matter provides scalable user experiences such that business analysts without specific training can create and consume predictive models, while at the same time allowing power users the ability to exercise fine-grained control on all modeling aspects. The methods and systems are schedulable and repeatable so that results can update over time to indicate changes in the trends underlying the data.

### Example Operating Environment

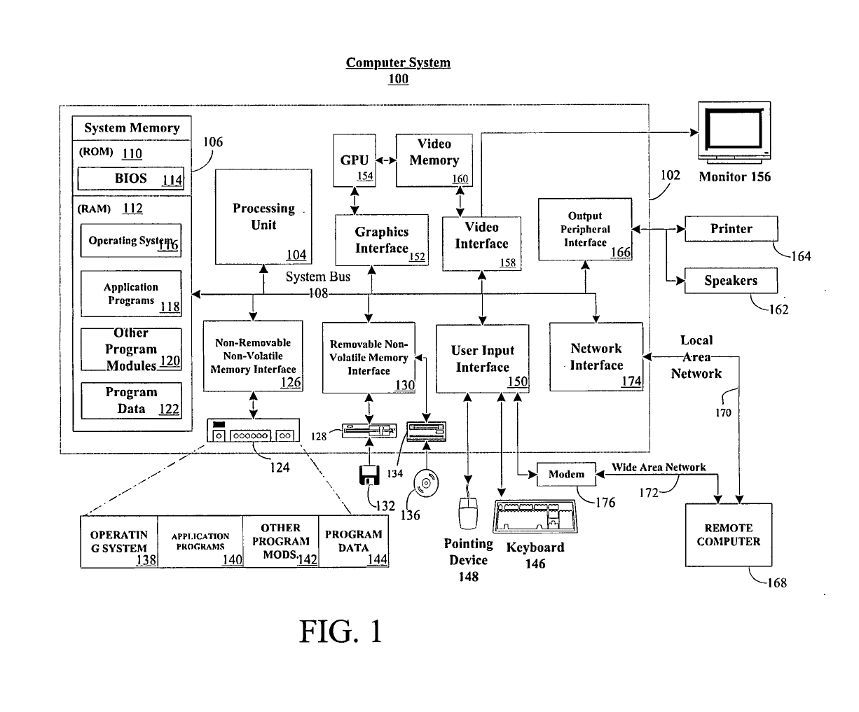

FIG. 1 is a block diagram illustrating a computer system 100 that can be programmed to implement various embodiments described herein. The computer system 100 is only one example of a suitable computing environment and is not intended to suggest any limitation as to the scope of use or functionality of the subject matter described herein. The computer system 100 should not be construed as having any dependency or requirement relating to any one component or combination of components shown in FIG. 1.

The computer system 100 includes a general computing device, such as a computer 102. Components of the computer 102 may include, without limitation, a processing unit 104, a system memory 106, and a system bus 108 that communicates data between the system memory 106, the processing unit 104, and other components of the computer 102. The system bus 108 may incorporate any of a variety of bus structures including a memory bus or memory controller, a peripheral bus, and a local bus using any of a variety of bus architectures. These architectures include, without limitation, Industry Standard Architecture (ISA) bus, Enhanced ISA (EISA) bus, Micro Channel Architecture (MCA) bus, Video Electronics Standards Association (VESA) local bus, and Peripheral Component Interconnect (PCI) bus, also known as Mezzanine bus.

The computer 102 also is typically configured to operate with one or more types of processor readable media or computer readable media, collectively referred to herein as “processor readable media.” Processor readable media includes any available media that can be accessed by the computer 102 and includes both volatile and non-volatile media, and removable and non-removable media. By way of example, and not limitation, processor readable media may include storage media and communication media. Storage media includes both volatile and non-volatile, and removable and non-removable media implemented in any method or technology for storage of information such as processor-readable instructions, data structures, program modules, or other data. Storage media includes, but is not limited to, RAM, ROM, EEPROM, flash memory or other memory technology, CD-ROM, digital versatile discs (DVDs) or other optical disc storage, magnetic cassettes, magnetic tape, magnetic disk storage or other magnetic storage devices, or any other medium that can be used to store the desired information and that can be accessed by the computer 102. Communication media typically embodies processor-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared, and other wireless media. Combinations of any of the above are also intended to be included within the scope of processor readable media.

The system memory 106 includes computer storage media in the form of volatile memory, non-volatile memory, or both, such as read only memory (ROM) 110 and random access memory (RAM) 112. A basic input/output system (BIOS) 114 contains the basic routines that facilitate the transfer of information between components of the computer 102, for example, during start-up. The BIOS 114 is typically stored in ROM 110. RAM 112 typically includes data, such as program modules, that are immediately accessible to or presently operated on by the processing unit. 104. By way of example, and not limitation, FIG. 1 depicts an operating system 116, application programs 118, other program modules 120, and program data 122 as being stored in RAM 112.

The computer 102 may also include other removable or non-removable, volatile or non-volatile computer storage media. By way of example, and not limitation, FIG. 1 illustrates a hard disk drive 124 that communicates with the system bus 108 via a non-removable memory interface 126 and that reads from or writes to a non-removable, non-volatile magnetic medium, a magnetic disk drive 128 that communicates with the system bus 108 via a removable memory interface 130 and that reads from or writes to a removable, non-volatile magnetic disk 132, and an optical disk drive 134 that communicates with the system bus 108 via the interface 130 and that reads from or writes to a removable, non-volatile optical disk 136, such as a CD-RW, a DVD-RW, or another optical medium. Other computer storage media that can be used in connection with the computer system 100 include, but are not limited to, flash memory, solid state RAM, solid state ROM, magnetic tape cassettes, digital video tape, etc.

The devices and their associated computer storage media disclosed above and illustrated in FIG. 1 provide storage of computer readable instructions, data structures, program modules, and other data that are used by the computer 102. In FIG. 1, for example, the hard disk drive 124 is illustrated as storing an operating system 138, application programs 140, other program modules 142, and program data 144. These components can be the same as or different from the operating system 116, the application programs 118, the other program modules 120, and the program data 122 that are stored in the RAM 112. In any event, the components stored by the hard disk drive 124 are different copies from the components stored by the RAM 112.

A user may enter commands and information into the computer 102 using input devices, such as a keyboard 146 and a pointing device 148, such as a mouse, trackball, or touch pad. These and other input devices may be connected to the processing unit 104 via a user input interface 150 that is connected to the system bus 108. Alternatively, input devices can be connected to the processing unit 104 via other interface and bus structures, such as a parallel port, a game port, or a universal serial bus (USB).

A graphics interface 152 can also be connected to the system bus 108. One or more graphics processing units (GPUs) 154 may communicate with the graphics interface 152. A monitor 156 or other type of display device is also connected to the system bus 108 via an interface, such as a video interface 158, which may in turn communicate with video memory 160. In addition to the monitor 156, the computer system 100 may also include other peripheral output devices, such as speakers 162 and a printer 164, which may be connected to the computer 102 through an output peripheral interface 166.

The computer 102 may operate in a networked or distributed computing environment using logical connections to one or more remote computers, such as a remote computer 168. The remote computer 168 may be a personal computer, a server, a router, a network PC, a peer device, or another common network node, and may include many or all of the components disclosed above relative to the computer 102. The logical connections depicted in FIG. 1 include a local area network (LAN) 170 and a wide area network (WAN) 172, but may also include other networks and buses. Such networking environments are common in homes, offices, enterprise-wide computer networks, intranets, and the Internet.

When the computer 102 is used in a LAN networking environment, it may be connected to the LAN 170 through a wired or wireless network interface or adapter 174. When used in a WAN networking environment, the computer 102 may include a modem 176 or other means for establishing communications over the WAN 172, such as the Internet. The modem 176 may be internal or external to the computer 102 and may be connected to the system bus 108 via the user input interface 150 or another appropriate component. The modem 176 may be a cable or other broadband modem, a dial-up modem, a wireless modem, or any other suitable communication device. In a networked or distributed computing environment, program modules depicted as being stored in the computer 102 may be stored in a remote memory storage device associated with the remote computer 168. For example, remote application programs may be stored in such a remote memory storage device. It will be appreciated that the network connections shown in FIG. 1 are exemplary and that other means of establishing a communication link between the computer 102 and the remote computer 168 may be used.

### Generating Reproducible Reports Used in Predictive Modeling Actions

A method, system, and apparatus are provided for producing reproducible reports that describe one or more analytical functions. These generated reports describe a sequence of analytical functions and allow subsequent executions of the same sequence of analytical functions for ease of use. The matrix space that is inherent to worksheets is used to record a sequence of operations as a tabular report that can be interpreted by a computer program. Independent formatting and other aesthetic enhancements can be included in the report. In addition, the tabular report can also include other enhancements that increase report readability without affecting the ability of a computer program to execute the report.

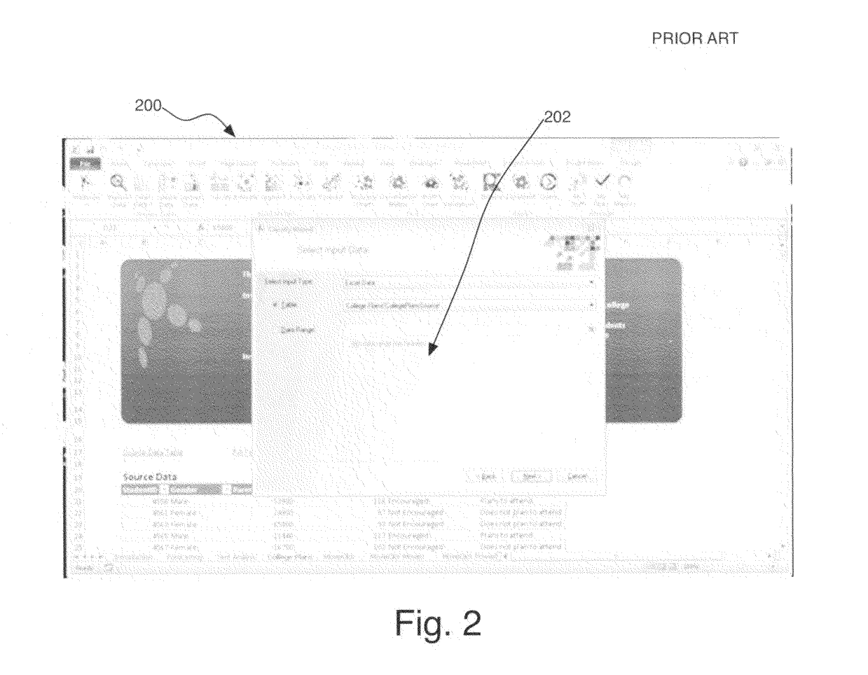

In some conventional applications, a task can be initiated by launching a wizard. For example, FIG. 2 illustrates a conventional graphical user interface (GUI) 200 for initiating a task in a spreadsheet environment, such as the EXCEL® spreadsheet environment available from Microsoft Corporation. The GUI 200 includes a wizard 202, which is a dialog box that guides the user through selecting options for the task.

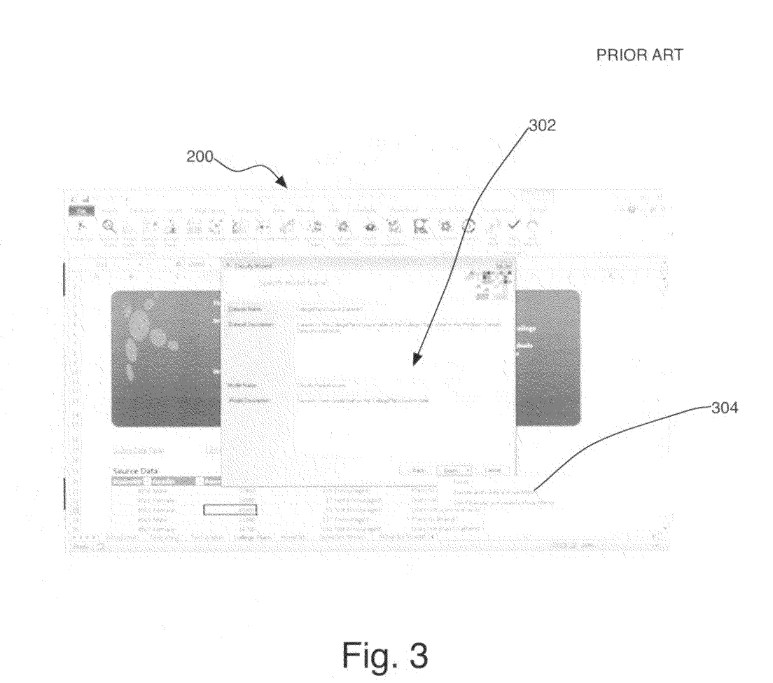

FIG. 3 illustrates a last page 302 of the wizard 202. The user can select an option 304 to execute the task and create a Visual macro. According to the disclosed embodiments, new options, such as an option to produce a reproducible report, are included in a wizard. These options are not shown in the conventional wizard 202 illustrated in FIG. 3.

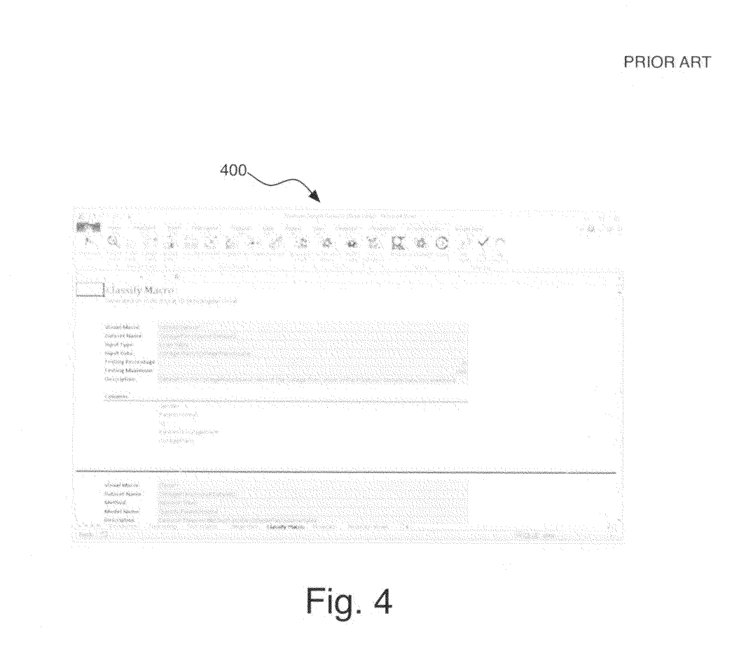

FIG. 4 illustrates an execution report 400 for visually inspecting a task execution plan in the spreadsheet environment. After the user has completed the wizard 202, the spreadsheet environment generates the execution report 400. The execution report 400 describes the parameters of the last action. All of the parameters that were selected in the wizard 202 are included in the execution report 400. The user can visually inspect the execution plan and modify parameters in the execution report 400.

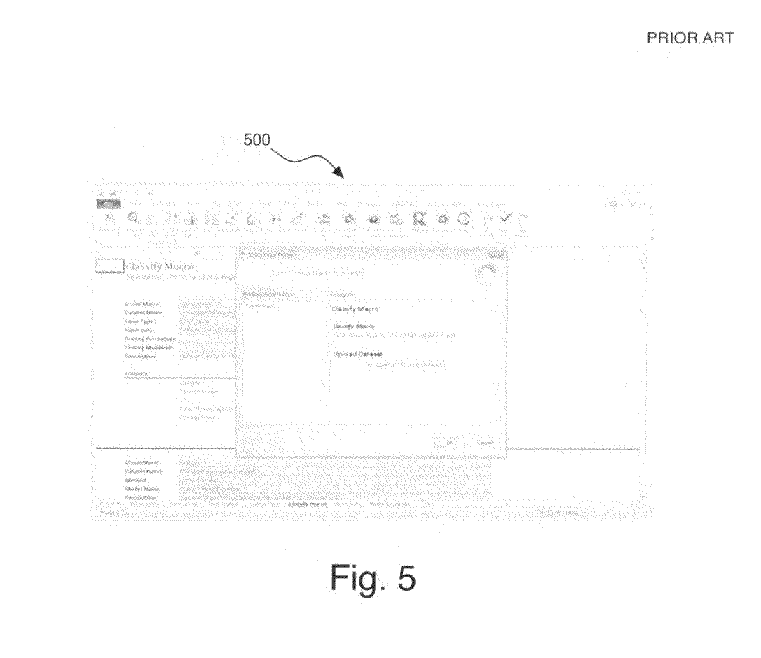

FIG. 5 illustrates a conventional graphical user interface 500 for re-executing the execution report 400. In addition to re-executing the execution report 400, the spreadsheet environment can also execute multiple execution reports 400 at once.

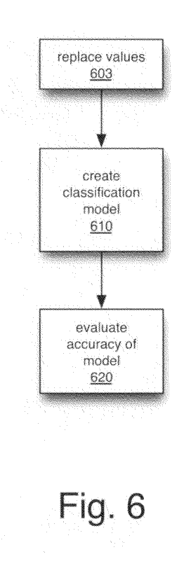

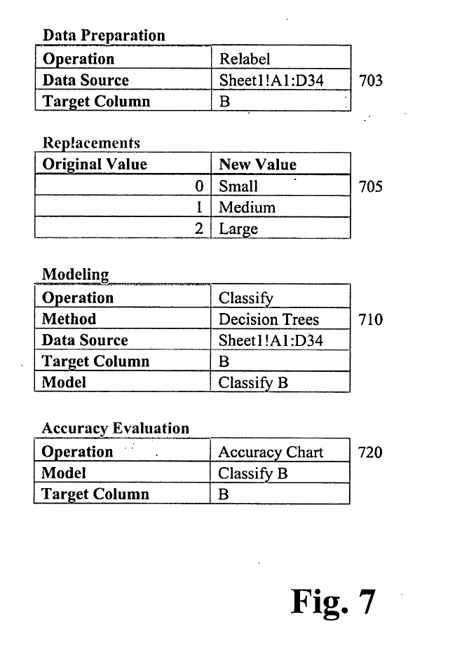

According to a disclosed embodiment, FIG. 6 is a flow diagram illustrating an example method 600 for providing a reproducible report for performing a reproducible task according to one disclosed embodiment. FIG. 7 is an example graphical user interface for providing a reproducible report according to the method 600. The example graphical user interface of FIG. 7 comprises a number of tables 703, 705, 710, and 720 that store parameters that relate to various aspects of the reproducible task. These aspects may include, for example, the type of operation to be performed, the data on which the operation is to be performed, and a method or algorithm to be used in performing the operation. The tables can be implemented using ranges within a single worksheet or across multiple worksheets in a workbook. In some embodiments, more or fewer tables may be included.

The method 600 involves a sequence of data preparation, modeling, and accuracy evaluation. By way of example and not limitation, this sequence is disclosed as being executed on top of a worksheet range (column A, row 1 to column D, row 34 in Sheet 1 of a general workbook.

In particular, at a data preparation step 603 illustrated in a table 703, values in a column (column B) are replaced with other values more appropriate for the classification task to be performed. The original and replacement values are shown in FIG. 7 in a table 705. For a classification task, for example, values of 0, 1, and 2 may be respectively replaced by values of “small,” “medium,” and “large.”

After the data preparation step 603, at a modeling step 610 illustrated in a table 710, a classification model is created using a Decision Trees algorithm on top of the prepared data. A different algorithm may be specified for creating the classification model by changing the value of the cell adjacent to the cell labeled “Method” in the table 710. In this way, the user can exercise control over the modeling step 610. Further, it will be appreciated that other types of models can be created for other types of reproducible tasks; the classification model is used for a classification task.

After the modeling step 610, at an accuracy evaluation step 620 illustrated in a table 720, the accuracy of the newly created classification model is evaluated.

The disclosed embodiments handle data differently and may be more cost-effective and efficient than conventional report software. The disclosed embodiments may reduce or eliminate the requirement that every user understand the requirements of a series of steps in order to repeatedly produce the same reports.

It will be understood by those who practice the embodiments described herein and those skilled in the art that various modifications and improvements may be made without departing from the spirit and scope of the disclosed embodiments. The scope of protection afforded is to be determined solely by the claims and by the breadth of interpretation allowed by law.

What is claimed is:

1. A computer system comprising:
a processor configured to receive and to execute processor-executable instructions;
a memory device in communication with the processor and storing processor-executable instructions that, when executed by the processor, cause the processor to:
provide a spreadsheet environment;
define a worksheet in the spreadsheet environment, the worksheet comprising a plurality of cells, each cell storing a respective value;
replace values in at least a subset of the plurality of cells with replacement values;
create a model for performing a reproducible task; and
evaluate the accuracy of the model for performing the reproducible task, wherein the processor replaces the values, creates the model, and evaluates the accuracy of the model based on a plurality of parameters contained in a table.

2. The computer system of claim 1, wherein the plurality of parameters comprises a parameter identifying an algorithm for performing the reproducible task.

3. The computer system of claim 1, wherein the plurality of parameters comprises a parameter identifying a range of cells of the worksheet on which the reproducible task is to be performed.

4. The computer system of claim 1, wherein the table contains the replacement values.

5. The computer system of claim 1, wherein the table contains a nonfunctional aesthetic enhancement.

6. The computer system of claim 1, wherein the reproducible task is a classification task.

7. A computer-implemented method of generating a reproducible task report, the method comprising:
using a computer to provide a spreadsheet environment;
defining a worksheet in the spreadsheet environment, the worksheet comprising a plurality of cells, each cell storing a respective value;
replacing values in at least a subset of the plurality of cells with replacement values;
creating a model for performing a reproducible task; and
evaluating the accuracy of the model for performing the reproducible task,
wherein the steps of replacing the values, creating the model, and evaluating the accuracy of the model are performed based on a plurality of parameters contained in a table.

8. The computer-implemented method of claim 7, wherein the plurality of parameters comprises a parameter identifying an algorithm for performing the reproducible task.

9. The computer-implemented method of claim 7, wherein the plurality of parameters includes a parameter identifying a range of cells of the worksheet on which the reproducible task is to be performed.

10. The computer-implemented method of claim 7, wherein the table contains the replacement values.

11. The computer-implemented method of claim 7, wherein the table contains a nonfunctional aesthetic enhancement.

12. The computer-implemented method of claim 7, wherein the reproducible task is a classification task.

13. A computer readable storage medium, other than a signal, storing computer-executable instructions that, when executed by a computer, cause the computer to perform a method comprising steps of:
providing a spreadsheet environment;
defining a worksheet in the spreadsheet environment, the worksheet comprising a plurality of cells, each cell storing a respective value;
replacing values in at least a subset of the plurality of cells with replacement values;
creating a model for performing a reproducible task; and
evaluating the accuracy of the model for performing the reproducible task, wherein the steps of replacing the values, creating the model, and evaluating the accuracy of the model are performed based on a plurality of parameters contained in a table.

14. The computer readable storage medium of claim 13, wherein the plurality of parameters comprises a parameter identifying an algorithm for performing the reproducible task.

15. The computer readable storage medium of claim 13, wherein the plurality of parameters comprises a parameter identifying a range of cells of the worksheet on which the reproducible task is to be performed.

16. The computer readable storage medium of claim 13, wherein the table contains the replacement values.

17. The computer readable storage medium of claim 13, wherein the table contains a nonfunctional aesthetic enhancement.

18. The computer readable storage medium of claim 13, wherein the reproducible task is a classification task.
